(19) United States
(12) Patent Application Publication
(10) Pub. No.: US 2019/0106021 A1
(43) Pub. Date: Apr. 11, 2019

(54) DYNAMICALLY CONFIGURABLE PASSENGER SECTION FOR PASSENGER TRANSPORT

(71) Applicant: GM Global Technology Operations LLC, Detroit, MI (US)

(72) Inventors: Edgar J. Dietrich, Redwood City, CA (US); Spencer W. Chamberlain, Sterling Heights, MI (US); Jim K. Rainbolt, Haslett, MI (US); Janet S. Goings, Commerce Township, MI (US); Scott L. Lumsden, Rochester Hills, MI (US)

(21) Appl. No.: 15/725,411

(22) Filed: Oct. 5, 2017

(51) Int. Cl. B60N 2/02

(52) U.S. Cl. CPC B60N 2/0292; G05D 1/0088; B60N 2/0224

(57) ABSTRACT

Embodiments include methods, systems and computer readable storage medium for dynamically configuring a passenger section for a passenger transport. The method includes receiving, by a processor, a trip request. The method further includes reconfiguring, by the processor, at least a portion of a passenger section of a passenger transport based at least in part on the received trip request. The method further includes collecting, by the passenger transport, one or more passengers associated with the trip request for transport to a destination.

### INTRODUCTION

The subject disclosure relates to rideshare services, and more specifically to dynamically configuring a passenger section of a passenger transport within a rideshare system.

Real-time ridesharing (also called dynamic, on-demand or instant ridesharing) is an automated service that matches drivers and users requesting one-way ridesharing services on very short notice. Real-time ridesharing (ridesharing) typically employs some form of navigation services/devices, applications for drivers to receive notifications for passenger pickup and applications for users to request ridesharing services. Ridesharing functionality in light of new technologies, for example, autonomous vehicles, are increasingly being considered.

Autonomous vehicles are automobiles that have the ability to operate and navigate without human input. Autonomous vehicles use sensors, such as radar, LIDAR, global positioning systems, and computer vision, to detect the vehicle's surroundings. Advanced computer control systems interpret the sensory input information to identify appropriate navigation paths, as well as obstacles and relevant signage. Some autonomous vehicles update map information in real time to remain aware of the autonomous vehicle's location even if conditions change or the vehicle enters an uncharted environment. Autonomous vehicles increasingly communicate with remote computer systems and with one another using V2X communications (Vehicle-to-Everything, Vehicle-to-Vehicle, Vehicle-to-Infrastructure).

Accordingly, it is desirable to provide a system that can allow a passenger section of a passenger transport to be dynamically configured based on user needs. The user needs can be related to, for example, space, privacy, security, refreshments/amenities, convenience etc.

### SUMMARY

In one exemplary embodiment, a method for dynamically configuring a passenger section for a passenger transport is disclosed. The method includes receiving, by a processor, a trip request. The method further includes reconfiguring, by the processor, at least a portion of a passenger section of a passenger transport based at least in part on the received trip request. The method further includes collecting, by the passenger transport, one or more passengers associated with the trip request for transport to a destination.

In addition to one or more of the features described herein, one or more aspects of the described method can additionally be related to a feature in which the reconfiguration uses one or more automated partitions to alter the passenger section. Another aspect can include determining whether passengers are already located in the passenger section and provides a warning to passengers already located in the passenger section related to operation of the one or more automated partitions and in which the altered passenger section is a passenger section having a plurality of sub-sections. Another aspect can be related to a feature in which the reconfiguration uses one or more pods to alter the passenger section. Additionally, the one or more pods comprise contents associated with the trip request wherein the contents comprise at least one of food, beverages and miscellaneous items. In addition, the one or more pods are received by the passenger transport via automated delivery, autonomous delivery or manual delivery. Another aspect of the method can include a feature in which the passenger transport is a vehicle or an autonomous vehicle.

In another exemplary embodiment, a system for dynamically configuring a passenger section for a passenger transport is disclosed herein. The system one or more passenger transports in which each passenger transport includes a memory and processor in which the processor is operable to receive a trip request. The processor is further operable to reconfigure at least a portion of a passenger section of the passenger transport based at least in part on the received trip request. A passenger transport of the one or more passenger transports that is associated with the trip request is operable collect one or more passengers for transport to a destination.

In yet another exemplary embodiment a computer readable storage medium for dynamically configuring a passenger section for a passenger transport is disclosed herein. The computer readable storage medium includes receiving a trip request. The computer readable storage medium further includes reconfiguring at least a portion of a passenger section of a passenger transport based at least in part on the received trip request. The computer readable storage medium further includes collecting one or more passengers associated with the trip request for transport to a destination.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 is an illustration of a passenger transport application that can be used by a patron to request passenger transport including a modification to an associated passenger section of the passenger transport associated according to one or more embodiments;

FIG. 4 is an illustration of plurality of possible passenger section configurations for a passenger transport according to one or more embodiments;

FIGS. 5A-5D are illustrations of a plurality of possible passenger section partition configurations according to one or more embodiments;

FIG. 6 is an illustration of a possible passenger section configuration based on amenities; and

FIG. 7 is a flow diagram of a method for dynamically configuring a passenger section for passenger transport according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

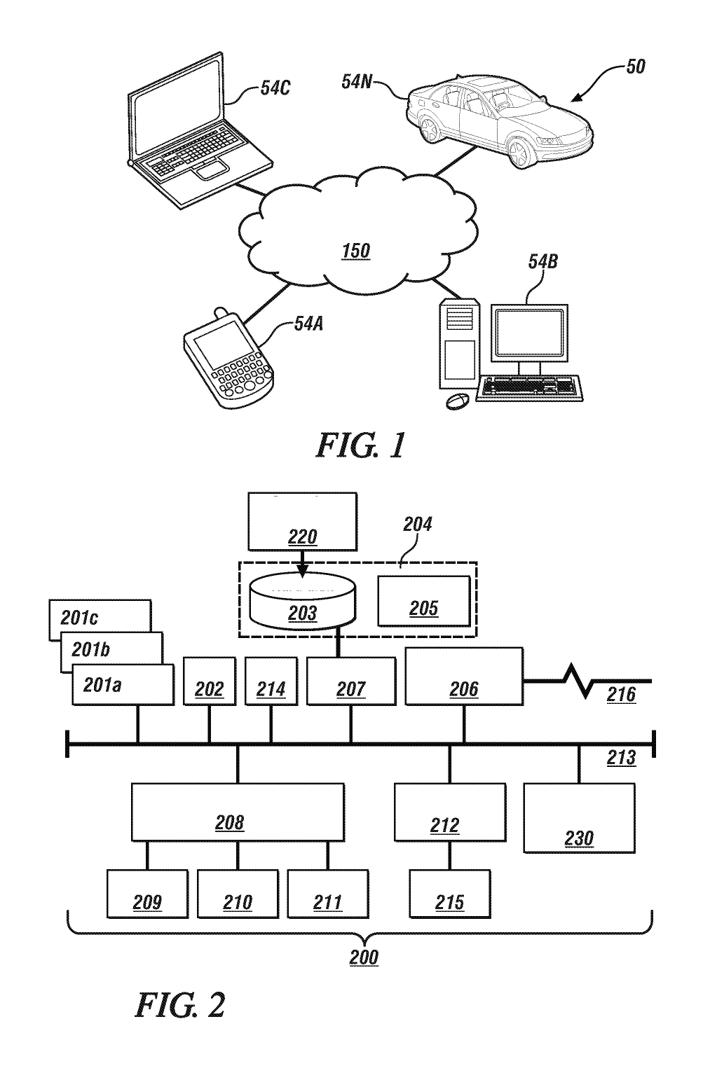

In accordance with an exemplary embodiment, FIG. 1 illustrates a computing environment 50 associated with a system for dynamically configuring a passenger section for passenger transport (ex., a motor vehicle). As shown, computing environment 50 comprises one or more computing devices, for example, a personal digital assistant (PDA) or cellular telephone (mobile device) 54A, a server 54B, a computer 54C, and/or an automobile onboard computer system 54N, which are connected via a network 150. The one or more computing devices may communicate with one another using network 150.

Network 150 can be, for example, a local area network (LAN), a wide area network (WAN), such as the Internet, a dedicated short range communications network, or any combination thereof, and may include wired, wireless, fiber optic, or any other connection. Network 150 can be any combination of connections and protocols that will support communication between mobile device 54A, server 54B, computer 54C, and/or vehicle on-board computer system 54N, respectively.

The mobile device 54A and vehicle associated with the vehicle on-board computer system 54N can include a GPS transmitter/receiver (not shown) which is operable for receiving location signals from the plurality of GPS satellites (not shown) that provide signals representative of a location for each of the mobile resources, respectively. In addition to the GPS transmitter/receiver, the mobile device 54A and vehicle associated with the vehicle on-board computer system 54N may include a navigation processing system that can be arranged to communicate with server 54B through the network 150. Accordingly, the mobile device 54A and vehicle associated with the vehicle on-board computer system 54N are able to determine location information and transmit that location information to the server 54B.

Additional signals sent and received may include data, communication, and/or other propagated signals. Further, it should be noted that the functions of transmitter and receiver could be combined into a signal transceiver.

In accordance with an exemplary embodiment, FIG. 2 illustrates a processing system 200 for implementing the teachings herein. The processing system 200 can form at least a portion of the one or more computing devices, such as mobile device 54A, server 54B, computer 54C, and/or vehicle on-board computer system 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220, for execution on the processing system 200, may be stored in mass storage 204. Network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

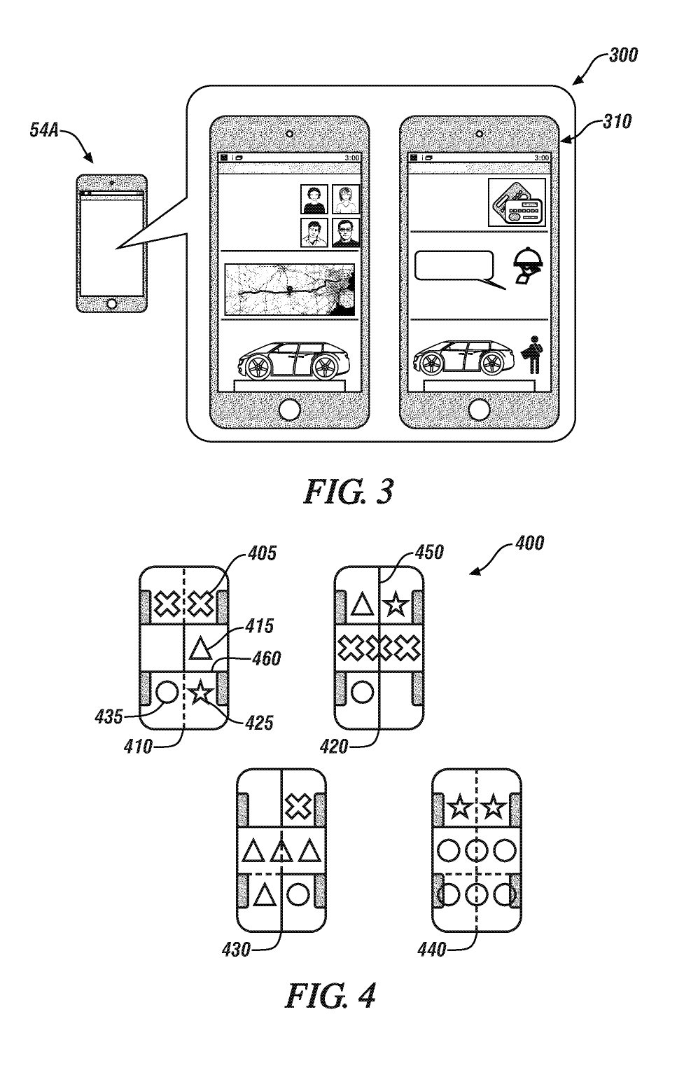

FIG. 3 depicts a mobile device 54A and a passenger transport application 310 used to interact with server 54B in order to allow a patron to request passenger transport (trip) to a destination including a modification of an associated passenger section of the passenger transport associated with the vehicle on-board computer system 54N, according to one or more embodiments. The passenger transport application 310 can allow the requesting patron to input details about the requested trip, which can be used to appropriately fulfill the requesting patron's request.

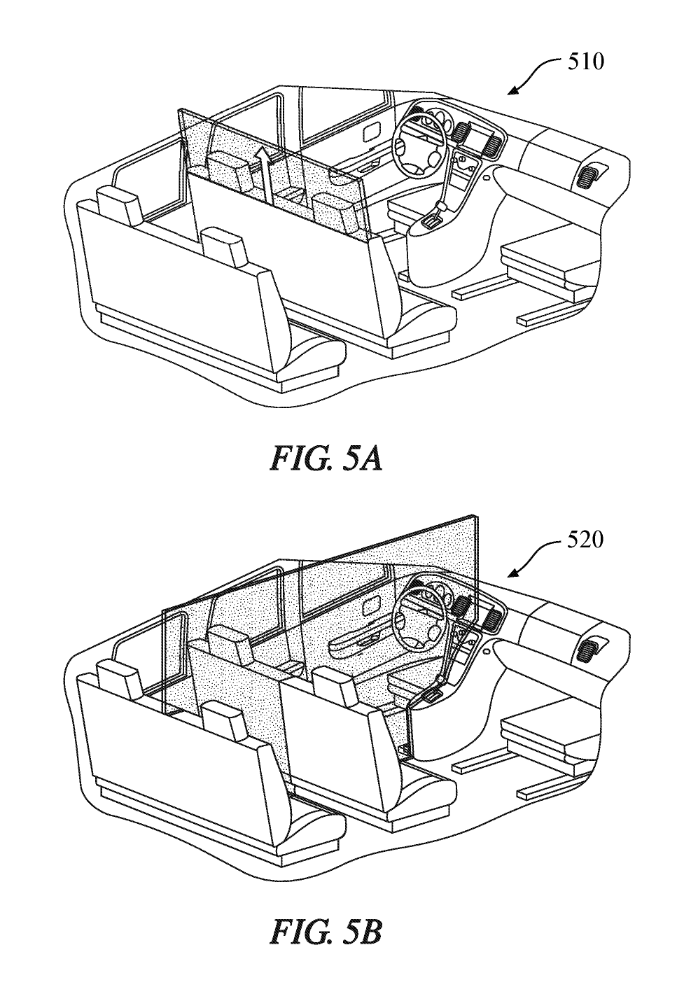

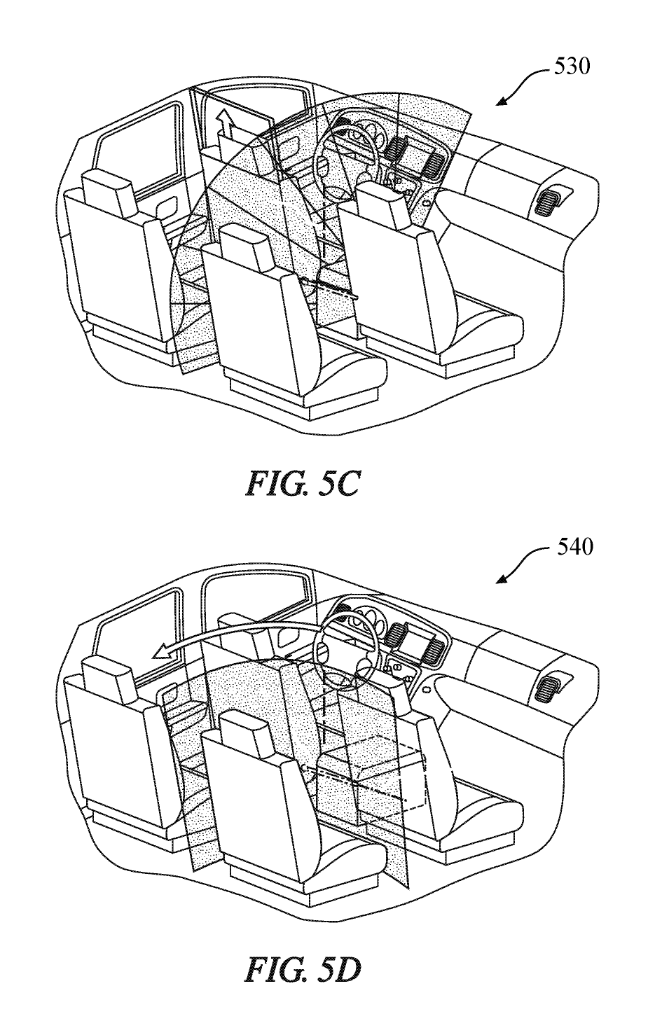

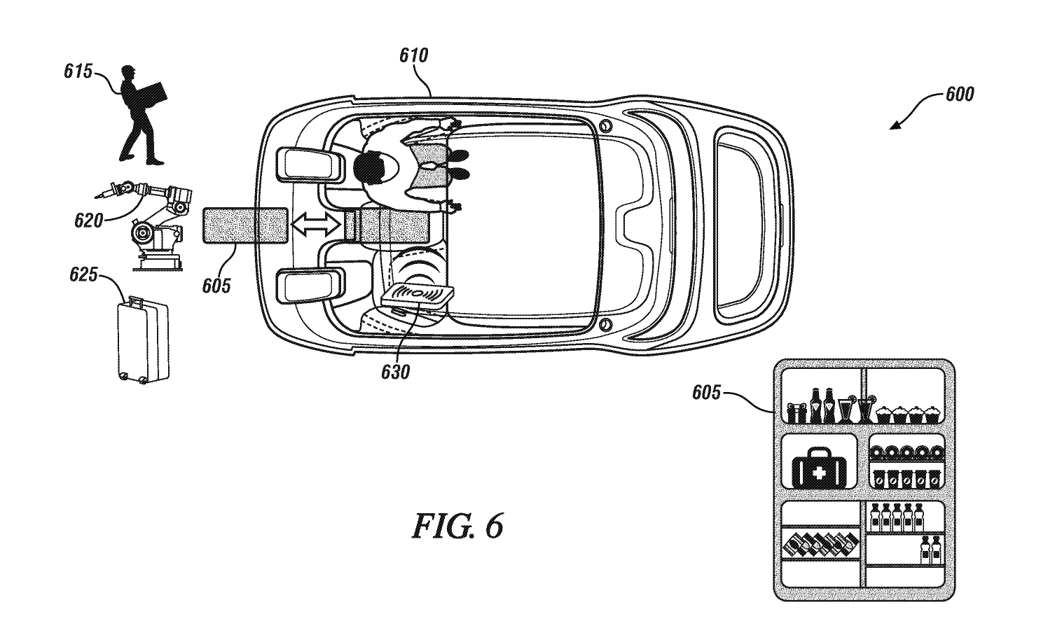

For example, the passenger transport application 310 can receive patron input related to any or the following: a passenger pickup location; a passenger destination location; a number of passengers associated with the trip; other passenger details associated with the trip; a time for a requested pickup; preferred music; trip type; amenities/refreshments for an individual/group associated with the trip (described further below in FIG. 6); configuration and/or privacy details associated with the trip (described further below in FIG. 4 and FIG. 5); a desired passenger transport type or the like. One or more of the associated inputs can be stored as user preferences or input manually by the requesting patron. The passenger transport application 310 can also accept payment for the trip.

FIG. 4 depicts a plurality of possible passenger section configurations 400 based on one or more requests for passenger transport according to one or more embodiments. Passenger transports according to the one or more embodiments are any form of transportation capable of transporting one or more passengers, for example, vehicles, autonomous vehicles, trains, buses, aircraft or the like. Passenger transports according to the one or more embodiments employ a passenger section capable of being altered to accommodate passenger space/privacy requests dynamically. Upon receipt of a trip request from a passenger transport application 310, server 54B can analyze the trip request to determine requirements necessary to fulfill the trip request.

In response to the received input, server 54B can utilize a variety of files/applications to select one or more passenger transports that can fulfill the trip request. For example, the server 54B can access files related to passenger transports that could fulfil the trip request to narrow passenger transport candidates to fulfill the trip request. Criteria for narrowing possible passenger transports to fulfill the trip request can be associated with passenger transport type, number of passengers, location of the passenger transport in relation to the requestor(s), and configuration capabilities. Server 54B can further narrow passenger transport candidates by communicating with the potential passenger transports via network 150 to determine current seating availability for each passenger transport. In addition, the server 54B can analyze requested amenities/refreshments, health sensitivities, current and requested privacy/security partitioning requirements associated with the trip request; calculate cargo requirements associated with the trip request and compare passenger transport trunk/cargo area dimensions; or the like. The server 54B can process information associated with the accessed files, as well as any criteria to narrow possible passenger transports in order to determine one or more possible candidate passenger transports to fulfill the trip request. The one or more possible candidate passenger transports can be transmitted to the passenger transport application 310 where the requesting patron can select a desired passenger transport.

Upon receipt of the selected passenger transport, server 54B can communicate with the selected passenger transport and transmit the trip request and associated details to the selected passenger transport. The selected passenger transport can dynamically configure/reconfigure the passenger section into sub-sections (ex., 410, 420, 430 or 440) to fulfill the received trip request, if necessary.

Passenger section 410 can utilize one or more automated section partitions (450 and/or 460) to create sub-sections in order to separate passengers and/or cargo in response to the received trip request. The automated partitions 450 and 460 can be used in conjunction with one or more on-board sensors used to monitor the passenger section 410 of the passenger transport. For example, the one or more sensors can be visual sensors used to obtain images of the passenger section 410; seat sensors used to determine one or more weight differentials within the passenger section 410; or the like. The one or more on-board sensors can be used to ensure automated divider operation occurs safely.

As illustrated, the passenger section 410 can be configured to provide transport for 3 groups (405, 415 and 425), as well as provide storage 435. The passenger section 410 has a configuration that can accommodate two passenger requests for individual trips with private space for each passenger (415 and 425—one with cargo request 425/435). In addition, the passenger section 410 can accommodate a request for 2 passengers with a private space for the 2 passengers.

Passenger sections 420, 430 and 440 illustrate other possible passenger section configurations that can be used to accommodate one or more groups of passengers. Passenger sections 410, 420, 430 and 440 are not the only possible configurations. Possible configurations can also be based on passenger transport size and capability.

FIGS. 5A-5D depict a plurality of possible passenger section partition configurations of automated partitions 450 and 460 that can be used to accommodate trip requests according to one or more embodiments. Configuration 510 of FIG. 5A can be used to separate a front passenger portion of a passenger section from a rear passenger portion of the passenger section. Configuration 520 of FIG. 5B can be used to separate a left passenger portion of a passenger section from a right passenger portion of the passenger section. Configuration 530 of FIG. 5C can also be used to separate a left passenger portion of a passenger section from a right passenger portion of the passenger section. Configuration 540 of FIG. 5D can be used to separate a passenger portion of a passenger section for an individual passenger. Configurations and partitions disclosed in relation to FIGS. 4 and 5 can be combined to fulfill a trip request.

FIG. 6 depicts a possible passenger section configuration 600 based on amenities according to one or more embodiments. When traveling to a destination, passengers may desire refreshments, amenities, or other miscellaneous items of convenience, especially on time-consuming trips. A passenger transport 610 can include a passenger section that can be configured to accommodate one or more amenities pods 605. The one or more amenities pods 605 can contain a plurality of sections. The location of the one or more amenties pods 605 within the passenger

transport 610 can vary depending on a number of requests for amenities, passengers and number of automated partitions in use within the passenger transport 610.

The one or more amenities pods 605 can be stocked with a wide array of food (meals, snacks, desserts, etc.), beverages and/or miscellaneous items (ex., medical kits, mobile device chargers, concierge items, etc.). For example, a patron may desire a passenger transport having a passenger transport type associated with large festive groups (a party bus) and/or a trip type associated with a party/celebration. Accordingly, the patron can utilize the passenger transport application 310 to request a party bus to travel to a desired location. In addition, the patron can also use the passenger transport application 310 to request partitioning of a private section if the party bus is to be shared by other parties, and request one or more amenities pods 605 for the requested trip. The patron can specify the contents of the one or more amenities pods 605, for example, a selection of snacks, water and adult beverages from one or more associated vendors, which can include third-party vendors. The vendors can receive the request for contents via a computing device, for example, computer 54C.

Upon stocking the one or more amenities pods 605 with the requested contents, the passenger transport 610 can be instructed by server 54B to reconfigure an associated passenger section to accommodate the one or more amenities pods 605. The one or more amenities pods 605 can be loaded into passenger transport 610 for use during the requested trip. The loading of the one or more amenities pods 605 can occur via automated delivery (620), autonomous delivery (625), manual delivery (615) or the like. The passenger transport 610 can travel to a fulfillment location to be stocked, or autonomous delivery (625) or manual delivery (615) can meet the passenger transport 610 at a designated location.

The one or more amenities pods 605 can contain insulation to maintain a temperature appropriate for the requested contents. A passenger transport power source 630 can be provided to provide power to the one or more amenities pods 605 to assist in maintaining an appropriate temperature for a given portion of the one or more amenities pods 605. Passenger sections disclosed in relation to FIGS. 4-6 can be combined to fulfill a trip request.

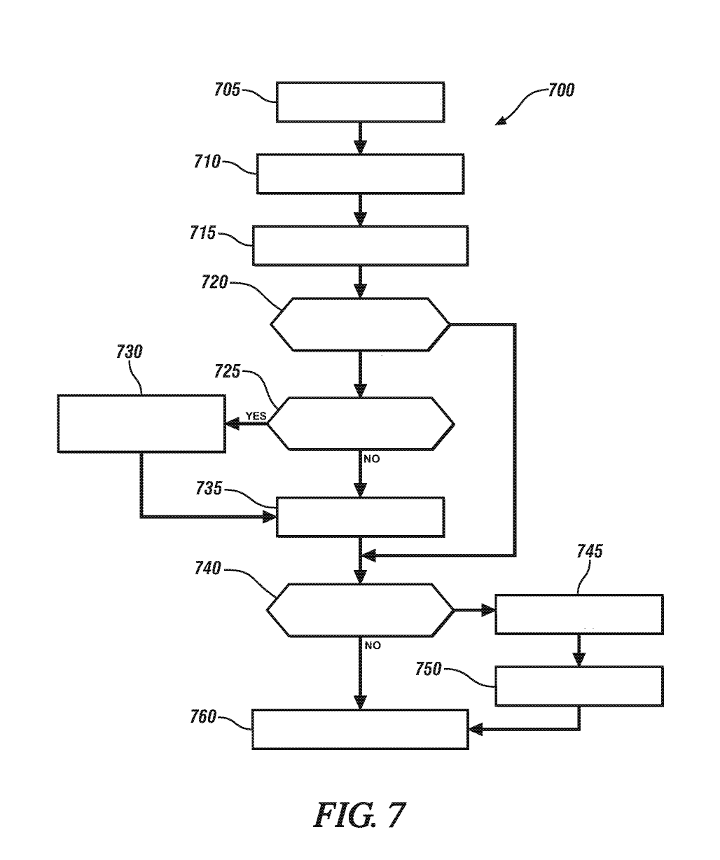

In accordance with an exemplary embodiment, FIG. 7 depicts a flow diagram of a method for dynamically configuring a passenger section for passenger transport 700. At block 705, a server, for example server 54B, receives a trip request for transportation to a destination from a patron, which can include a request for refreshments, amenities, and/or other miscellaneous items. At block 710, the server 54B can determine which passenger transports are available to fulfill the trip request and narrow the possible passenger transports that can fulfill the trip request information associated with the trip request. The server 54B can provide narrowed possible passenger transports to the patron, for example, in a list format through a passenger transport application 310. The patron can select a passenger transport from the list provided suiting the patron's needs.

At block 715, the server 54B can notify the selected passenger transport and provide details related to the associated trip request. At block 720, the selected passenger transport can determine if a passenger section of the passenger transports should be reconfigured in order to fulfill the received trip request. For example, one or more automated partitions may need to be altered to create more/less space or add/remove privacy. If the passenger section does not need reconfiguration based on the determination at block 720, the method 700 proceeds to block 740.

If the passenger section needs reconfiguration to fulfill aspects of the trip request, the method 700 proceeds to block 725 where the passenger transport can determine if passengers are already located in the passenger section of the passenger transport. If passengers are not currently located in the passenger section of the passenger transport, the method 700 proceeds to block 735. If passengers are currently located in the passenger section of the passenger transport, the passenger transport can provide a warning to the current passengers notifying the passenger(s) of an impending reconfiguration at block 730. At block 735, the passenger transport can perform the reconfiguration of the passenger section based on the trip request.

At block 740, the passenger transport can determine if reconfiguration/supply is needed to fulfill aspects of the trip request related to refreshments, amenities, and/or other miscellaneous items. If reconfiguration/supply is not needed, the method 700 proceeds to block 760. If reconfiguration/supply is needed, the method 700 proceeds to block 745 where one or more vendors are contacted to obtain contents requested in the trip request, which can be added to one or more amenities pods. At block 750, the one or more amenities pods can be added to the passenger transport. At block 760, the passenger transport can pickup/collect one or more passengers associated with the trip request in order to transport the one or more passengers to a destination in accordance with the trip request.

Accordingly, the embodiments disclosed herein describe a system provide a dynamically configurable passenger section for a passenger transport, for example, an autonomous vehicle, which can be customized to suit a passenger's needs. The system can be equipped with an amenities pod that can dock in a uniform fashion with the autonomous vehicle via a standard physical and electrical interface. The pods can be pre-loaded by a supplier and loaded into the autonomous vehicle manually or robotically. Empty pods can be retrieved by a third party upon consumption or be removed by individual passengers. Automated partitions within the autonomous vehicle can be used to reconfigure a passenger section of the autonomous vehicle, even in instances when the autonomous vehicle is enroute. The associated partitioning can be for the purpose of individual rider privacy, security and/or to rebalance passenger space versus cargo space.

The partitioning of a passenger transport section can be implemented for additional reasons than those discussed in relation to FIGS. 1-7. For example, a passenger section can be used for transporting cargo. Accordingly, sub-sections can be dynamically configured based on a number of associated delivery locations. Moreover, the passenger section can be dynamically configured in order to transport sensitive or dangerous items or individuals (ex., armored vehicles, military or prison transports). In addition, an autonomous vehicle containing sub-sections that can be dynamically configured in order to transport medicine and other medical supplies in a hospital setting.

It is understood that although the embodiments are described as being implemented on a traditional processing system, the embodiments are capable of being implemented in conjunction with any other type of computing environment now known or later developed. For example, the present techniques can be implemented using cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. It should be appreciated that the computing environment that is associated with an augmented rider identification and dynamic rerouting system can be implemented in a cloud computing environment, and pickup location information, routing/re-routing information, profile data/and or obtained image data can be stored locally and/or remotely, such as in the cloud computing environment.

Technical effects and benefits of the disclosed embodiments include, but are not limited to providing enhanced safety for rideshare occupants, eliminating the need to bring amenities for consumption during a trip and a passenger section to be sized accordingly, which can reduce energy consumption, emissions, and congestion.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for dynamically configuring a passenger section for a passenger transport, the method comprising:
receiving, by a processor, a trip request;
reconfiguring, by the processor, at least a portion of a passenger section of a passenger transport based at least in part on the received trip request; and
collecting, by the passenger transport, one or more passengers associated with the trip request for transport to a destination.

2. The method of claim 1, wherein the reconfiguration uses one or more automated partitions to alter the passenger section.

3. The method of claim 2, wherein the processor further determines whether passengers are already located in the passenger section and provides a warning to passengers already located in the passenger section related to operation of the one or more automated partitions.

4. The method of claim 2, wherein the altered passenger section is a passenger section having a plurality of sub-sections.

5. The method of claim 1, wherein the reconfiguration uses one or more pods to alter the passenger section.

6. The method of claim 5, wherein the one or more pods comprise contents associated with the trip request.

7. The method of claim 6, wherein the contents comprise at least one of food, beverages and miscellaneous items.

8. The method of claim 5, wherein the one or more pods are received by the passenger transport via automated delivery, autonomous delivery or manual delivery.

9. The method of claim 1, wherein the passenger transport is a vehicle or an autonomous vehicle.

10. A system for dynamically configuring a passenger section for a passenger transport, the system comprising:
one or more passenger transports, wherein each passenger transport comprises:
a memory; and
a processor coupled to the memory, wherein the processor is operable to:
receive a trip request; and
reconfigure at least a portion of a passenger section of at least one of the one or more passenger transports based at least in part on the received trip request;
wherein a passenger transport, of the one or more passenger transports, associated with the received trip request is operable to collect one or more passengers for transport to a destination.

11. The system of claim 10, wherein the reconfiguration uses one or more automated partitions to alter the passenger section.

12. The system of claim 11, wherein the processor is further operable to determine whether passengers are already located in the passenger section and provides a warning to passengers already located in the passenger section related to operation of the one or more automated partitions.

13. The system of claim 11, wherein the altered passenger section is a passenger section having a plurality of sub-sections.

14. The system of claim 10, wherein the reconfiguration uses one or more pods to alter the passenger section.

15. The system of claim 14, wherein the one or more pods comprise contents associated with the trip request, wherein the contents comprise at least one of food, beverages and miscellaneous items.

16. The system of claim 14 wherein the one or more pods are received by the passenger transport via automated delivery, autonomous delivery or manual delivery.

17. The system of claim 10, wherein the passenger transport is a vehicle or an autonomous vehicle.

18. A non-transitory computer readable storage medium having program instructions embodied therewith, the program instructions readable by a processor to cause the processor to perform a method for dynamically configuring a passenger section for a passenger transport comprising:
receiving a trip request;
reconfiguring at least a portion of a passenger section of a passenger transport based at least in part on the received trip request; and
collecting one or more passengers associated with the trip request for transport to a destination.

19. The computer readable storage medium of claim 18, wherein the reconfiguration uses one or more automated partitions to alter the passenger section.

20. The computer readable storage medium of claim 18 wherein the reconfiguration uses one or more pods to alter the passenger section.
